(19) United States
(12) Patent Application Publication
(10) Pub. No.: US 2026/0056686 A1
(43) Pub. Date: Feb. 26, 2026

(54) IMAGE FORMATION SYSTEM CAPABLE OF RESUMING PRINTING AFTER SUSPENSION OF PRINTING

(71) Applicant: KYOCERA Document Solutions Inc., Osaka (JP)

(72) Inventor: Tatsuya CHUTO, Osaka (JP)

(73) Assignee: KYOCERA Document Solutions Inc., Osaka (JP)

(21) Appl. No.: 19/295,630

(22) Filed: Aug. 10, 2025

(30) Foreign Application Priority Data
Aug. 20, 2024 (JP) 2024-139334

(51) Int. Cl. G06F 3/12

(52) U.S. Cl. CPC G06F 3/121; G06F 3/1234; G06F 3/1267

(57) ABSTRACT

An image formation system includes a digital front end and an image forming apparatus. When communication is interrupted due to a communication error during sending of image data from the digital front end to the image forming apparatus, the image forming apparatus does printing halfway in accordance with already received part of the image data. The digital front end stores information on pages of the image data left unprinted by the image forming apparatus and, after restart of the digital front end and the image forming apparatus, sends the information on the pages left unprinted to the image forming apparatus. The image forming apparatus resumes the printing in accordance with the information on the pages left unprinted.

### INCORPORATION BY REFERENCE

This application claims priority to Japanese Patent Application No. 2024-139334 filed on Aug. 20, 2024, the entire contents of which are incorporated by reference herein.

### BACKGROUND

The present disclosure relates to image formation systems capable of resuming printing after the printing is suspended due to a communication error.

In conventional image formation systems including a digital front end and an image forming apparatus, DVI (digital visual interface) cables are used for data exchanges. In case of interruption of data communication due to, for example, a failure of a DVI cable, the image forming apparatus checks for a communication error. When a communication error occurs, the image forming apparatus is powered off and, in this state, the DVI cable is replaced.

Recently, in image formation systems, a communication cable, such as an Ethernet cable, is increasingly being used instead of a DVI cable. The use of a communication cable has the merit of increasing the input performance of image data and versatility, but causes a communication error due to noise, static electricity or the like with high frequency. When a communication error occurs while image data is sent from the digital front end to the image forming apparatus, it is necessary that abnormality is detected and the image forming apparatus is appropriately restarted.

There is proposed a technique in which various versions of operations systems operable on information processing apparatuses communicable with printers appropriately notify the user of an error using a standard error notification function. There is also proposed an image forming apparatus that records, in job execution history, errors having occurred before the entry of a print job into the image forming apparatus.

Furthermore, a technique is proposed in which, in an image formation system including an image forming apparatus and a print control device, a previous status of connection of the image formation system is stored and, upon a new connection, the user is prompted to confirm settings so that appropriate measures for the new connection can be taken. A technique is also proposed in which when a communication error occurs between a digital front end and an image forming apparatus during printing, suspended processing is executed without trouble to the user.

### SUMMARY

A technique improved over the aforementioned techniques is proposed as one aspect of the present disclosure.

An image formation system according to an aspect of the present disclosure is an image formation system including a digital front end and an image forming apparatus. When communication is interrupted due to a communication error during sending of image data from the digital front end to the image forming apparatus, the image forming apparatus does printing halfway in accordance with already received part of the image data. The digital front end stores information on pages of the image data left unprinted by the image forming apparatus and, after restart of the digital front end and the image forming apparatus, sends the information on the pages left unprinted to the image forming apparatus. The image forming apparatus resumes the printing in accordance with the information on the pages left unprinted.

### BRIEF DESCRIPTION OF THE DRAWINGS

FIG. 1 is a schematic view of an image formation system.

FIG. 2 is a diagram showing an electrical configuration of the image formation system.

FIG. 3 is a flowchart showing the flow of start-up processing of the image formation system.

FIG. 4 is a flowchart showing the flow of print processing of the image formation system.

FIG. 5 is a flowchart showing the flow of communication error processing of the image formation system.

FIG. 6 is a flowchart showing the flow of restart processing of the image formation system.

### DETAILED DESCRIPTION

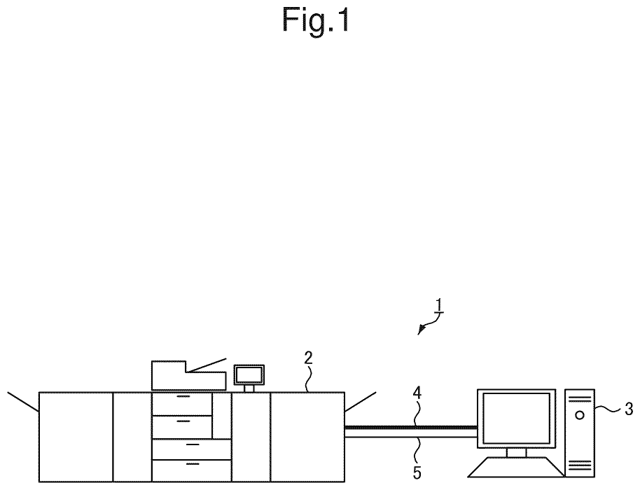

Hereinafter, a description will be given of an image formation system according to one embodiment of the present disclosure with reference to the drawings. FIG. 1 shows an example of a connection environment of the image formation system according to the one embodiment of the present disclosure. As shown in FIG. 1, the image formation system 1 is constituted by an image forming apparatus 2, a digital front end (hereinafter, referred to as a “DFE”) 3, and so on. The image forming apparatus 2 prints an image on a sheet in accordance with a print job sent from the DFE 3.

The DFE 3 is a device that does data processing for inputting data to the image forming apparatus 2. The DFE 3 externally controls the image forming apparatus 2 and includes a printer driver installed thereon in order to control printing on the image forming apparatus 2. The DFE 3 and the image forming apparatus 2 are communicably connected via a first communication cable 4 and a second communication cable 5. The first communication cable 4 is a cable connecting between the image forming apparatus 2 and the DFE 3 via gigabit Ethernet for use in sending image data and is, for example, a 10G Eth cable. The second communication cable 5 is a cable connecting between the image forming apparatus 2 and the DFE 3 via gigabit Ethernet for use in sending commands and control signals and is, for example, a 1G Eth cable.

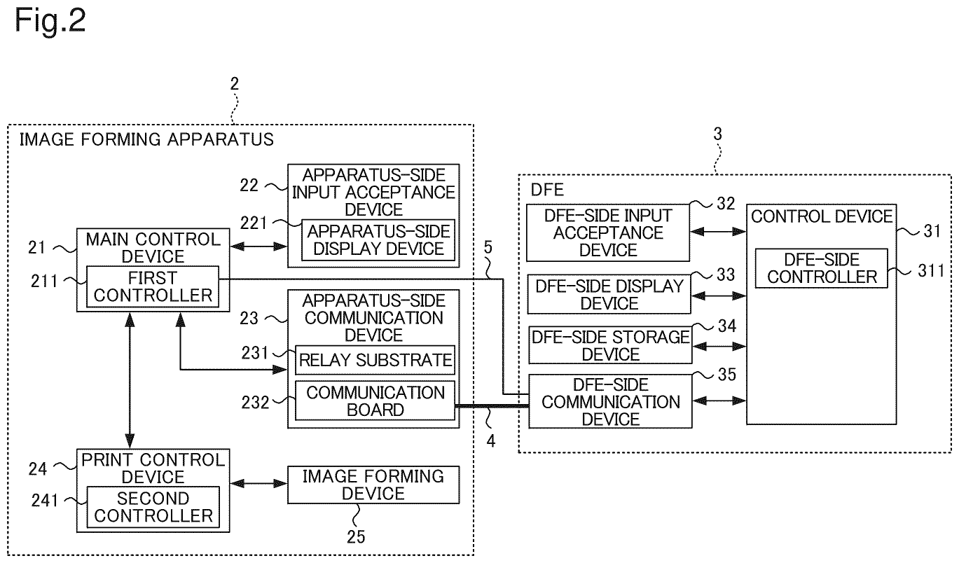

FIG. 2 is a diagram showing an electrical configuration of the image formation system 1 according to the one embodiment of the present disclosure. The image forming apparatus 2 includes a main control device 21, an apparatus-side input acceptance device 22, an apparatus-side communication device 23, a print control device 24, an image forming device 25, and so on.

The main control device 21 is constituted by a processor, a RAM (random access memory), a ROM (read only memory), and so on. The processor is, for example, a CPU (central processing unit), an MPU (micro processing unit) or an ASIC (application specific integrated circuit). When the processor executes a control program stored in the ROM or other storage, the main control device 21 functions as a first controller 211. The first controller 211 governs the overall operation control of the image forming apparatus 2.

The apparatus-side input acceptance device 22 includes hardware keys, including a decision key for giving a definite instruction for various operations or settings and a start key, and an apparatus-side display device 221. The apparatus-side display device 221 is, for example, an LCD (liquid crystal display) and displays an operation screen, a message or so on. The apparatus-side display device 221 may be formed integrally with a touch panel.

The apparatus-side communication device 23 includes a relay substrate 231 and a communication board 232. The relay substrate 231 controls the communication board 232. The communication board 232 transfers data via the first communication cable 4 to and from the DFE 3 under the control of the relay substrate 231.

The print control device 24 is constituted by a processor, a RAM, a ROM, and so on and, through the processor executing a control program stored in the ROM or other storage, functions as a second controller 241. The second controller 241 controls the operation of the image forming device 25. The image forming device 25 prints an image on a sheet in accordance with image data.

Next, a description will be given of the DFE 3. The DFE 3 is, for example, a computer. The DFE 3 includes a control device 31, a DFE-side input acceptance device 32, a DFE-side display device 33, a DFE-side storage device 34, a DFE-side communication device 35, and so on. The control device 31 is constituted by a processor, a RAM, a ROM, and so on and, through the processor executing a control program stored in the ROM or other storage, functions as a DFE-side controller 311. The DFE-side controller 311 governs the overall operation control of the DFE 3.

The DFE-side input acceptance device 32 is a keyboard or a pointing device, such as a mouse. The DFE-side display device 33 is, for example, an LCD (liquid crystal display) and displays an operation screen or so on. The DFE-side storage device 34 is a large-capacity storage device that is constituted by an SSD (solid state drive), an HDD (hard disk drive) or other storage device and stores various programs, a data table and so on.

The DFE-side communication device 35 is a communication module that transfers data to and from the image forming apparatus 2. The DFE-side communication device 35 performs data communication via the first communication cable 4 with the communication board 232 (the apparatus-side communication device 23). Furthermore, the DFE-side communication device 35 transfers commands and control signals via the second communication cable 5 to and from the first controller 211.

Among general image formation systems not according to this embodiment, there are those in which a DVI cable is used for data communications between the image forming apparatus and the DFE. The DVI cable extremely rarely causes a communication error due to a cause (for example, noise or static electricity) other than a cable failure while image data is sent from the DFE to the image forming apparatus. Therefore, any measures against communication errors are not provided to the image formation system. If a communication error occurs, there is no other choice than to power off the image forming apparatus and replace the DVI cable.

With the recent spread of gigabit Ethernet, in image formation systems, a communication cable, such as an Ethernet cable, is increasingly being used instead of a DVI cable. The use of a communication cable has the merit of increasing the input performance of image data and versatility.

However, with the use of a communication cable, such as an Ethernet cable, the frequency of communication errors during sending of image data increases under the influence of noise, static electricity or so on as compared to the use of a DVI cable. When a communication error occurs, sending and receiving of image data is interrupted. If printing is started over from the beginning at every interruption, the user will spend unnecessary time and trouble. Therefore, in using a communication cable, printing resumption after restart of the image forming apparatus should be appropriately done. Hereinafter, a description will be given of the operation of the image formation system 1 according to the present disclosure upon occurrence of a communication error.

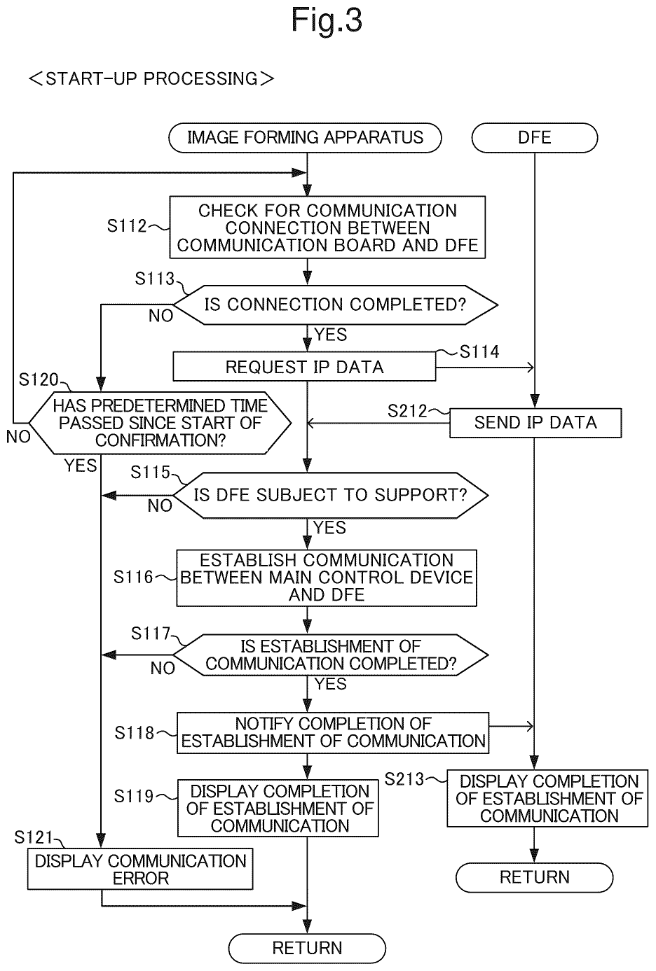

First, a description will be given of start-up of the image formation system 1. FIG. 3 is a flowchart showing the flow of start-up processing of the image formation system 1. The first controller 211 allows the apparatus-side communication device 23 to check for physical connection of the first communication cable 4 (S112). When the apparatus-side communication device 23 can confirm the completion of the physical connection (YES in S113), the first controller 211 confirms port connection between the apparatus-side communication device 23 and the DFE-side communication device 35 and allows the apparatus-side communication device 23 to request the DFE-side communication device 35 to send IP data (S114). In response to this request, the DFE-side communication device 35 sends IP data via the first communication cable 4 to the apparatus-side communication device 23 (S212).

The first controller 211 finds out identification information on the DFE 3 among the IP data received by the apparatus-side communication device 23 and determines whether or not the DFE 3 is subject to support (S115). When the DFE 3 is subject to support (YES in S115), the first controller 211 uses an IP address contained in the IP data to establish communication connection between the first controller 211 and the DFE-side communication device 35 via the second communication cable 5 (S116).

When the communication connection via the second communication cable 5 is established (YES in S117), the first controller 211 notifies the DFE-side communication device 35 via the second communication cable 5 of the completion of the establishment of communication (S118). Then, the first controller 211 allows the apparatus-side display device 221 to display a message indicating the completion of establishment of communication with the DFE 3 (S119). On the other hand, the DFE-side controller 311 allows the DFE-side display device 33 to display a message indicating the completion of establishment of communication with the image forming apparatus 2 (S213).

When in the processing in S113 the completion of physical connection of the first communication cable 4 cannot be confirmed (NO in S113), the first controller 211 allows the apparatus-side communication device 23 to repeat the confirmation of whether or not the physical connection is completed at predetermined time intervals (for example, at intervals of five seconds) (S112) unless a specified period of time passes (NO in S120). This predetermined time intervals can be arbitrarily changed by the user. When the completion of the physical connection cannot be confirmed even though the specified period of time has passed (YES in S120), the first controller 211 allows the apparatus-side display device 221 to display a message of a communication error (S121). Also while the apparatus-side display device 221 displays the message of a communication error, the first controller 211 may confirm whether or not the physical connection of the first communication cable 4 is completed.

When the DFE 3 is determined not to be subject to support (NO in S115), the first controller 211 allows the apparatus-side display device 221 to display an error message (S121). Furthermore, also when the second communication cable 5 has failed to establish communication between the main control device 21 and the DFE-side communication device 35 (NO in S117), the first controller 211 allows the apparatus-side display device 221 to display an error message (S121).

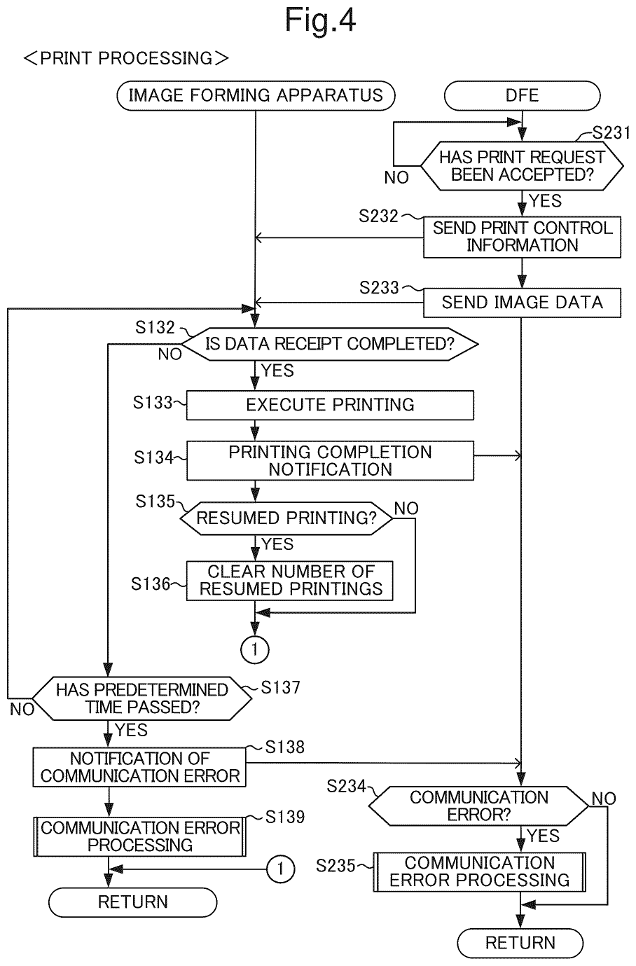

Next, a description will be given of print processing of the image formation system 1. FIG. 4 is a flowchart showing the flow of the print processing.

When the DFE-side controller 311 accepts a print request (YES in S231), it allows the DFE-side communication device 35 to send print control information to the first controller 211 of the image forming apparatus 2 (S232) and allows the DFE-side communication device 35 to send image data to the first controller 211 of the image forming apparatus 2 (S233).

In the image forming apparatus 2, when the apparatus-side communication device 23 completes the receipt of the image data, the first controller 211 notifies the second controller 241 of the completion of receipt of image data (YES in S132) and the second controller 241 allows the image forming device 25 to print an image based on the image data (S133). When the printing is completed, the second controller 241 notifies the first controller 211 of the completion of printing and the first controller 211 sends a printing completion notification indicating the completion of printing via the second communication cable 5 to the DFE-side communication device 35 of the DFE 3 (S134).

Then, the first controller 211 determines whether or not the printing executed in the processing in S133 is resumed printing due to a communication error (S135). When the executed printing is resumed printing (YES in S135), the first controller 211 resets and clears the number of resumed printings having been counted, for example, by a counter built in the first controller 211 (S136). A description about the number of resumed printings will be given later. Thereafter, the first controller 211 ends the processing.

If the receipt of image data of the apparatus-side communication device 23 is not completed even though a predetermined time (for example, two minutes) has passed (NO in S132 and YES in S137), the first controller 211 determines that this situation corresponds to a communication error, sends a notification of occurrence of a communication error via the second communication cable 5 to the DFE-side communication device 35 of the DFE 3 (S138), and proceeds to communication error processing (S139). When the DFE-side controller 311 accepts the notification of occurrence of a communication error (YES in S234), it proceeds to the communication error processing (S235).

An example of a cause of a communication error determined by the first controller 211 in the processing in S137 is a failure due to disconnection of the first communication cable 4 and other examples include an abnormality in image data checksum of the relay substrate 231 and an abnormality in image data size.

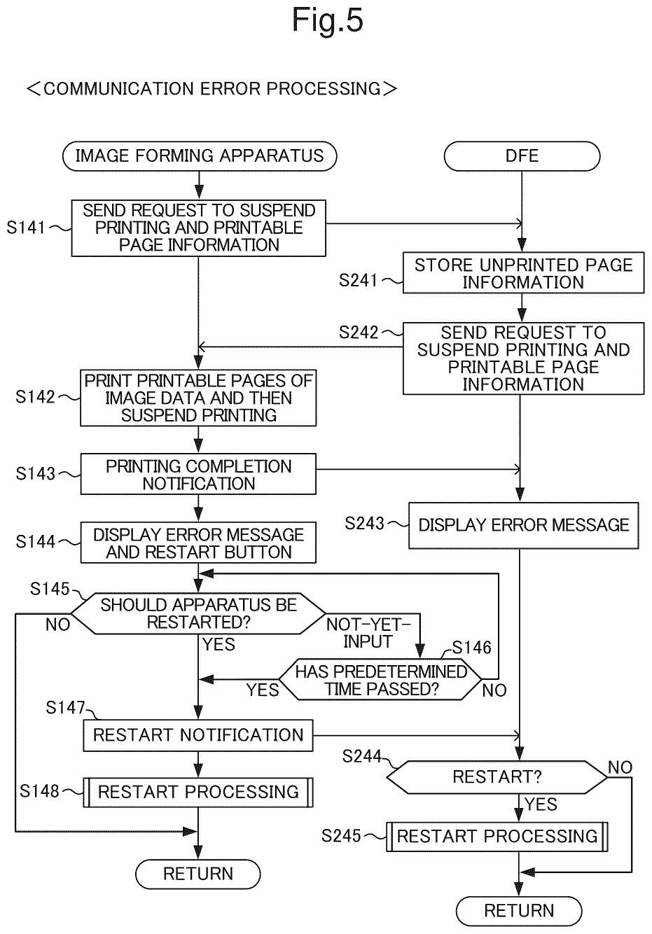

FIG. 5 is a flowchart showing the flow of communication error processing of the image formation system 1. The first controller 211 of the image forming apparatus 2 sends a request to suspend printing and printable page information via the second communication cable 5 to the DFE-side communication device 35 of the DFE 3 (S141). The printable page information is information containing the numbers of pages that the image forming device 25 can print using already received part of the image data. For example, assume that while, in the processing in S233, the DFE-side communication device 35 sends image data of 10 pages to the apparatus-side communication device 23, communication between both the communication devices is interrupted due to the occurrence of a communication error and, at that time, the apparatus-side communication device 23 has already received first to fifth pages of the image data (i.e., has not yet received sixth and subsequent pages of the image data). In this case, the first controller 211 sends to the DFE-side communication device 35 printable page information including information on the first to fifth pages which are part of the image data already received by the apparatus-side communication device 23.

Then, the DFE-side controller 311 of the DFE 3 determines, using the printable page information, the numbers of the pages left unprinted and allows the DFE-side storage device 34 to store unprinted page information including information on the numbers of the pages left unprinted (S241). For example, when the printable page information includes information on the first to fifth pages as described in the above example, the DFE-side controller 311 creates unprinted page information including information on the sixth to tenth pages and allows the DFE-side storage device 34 to store the created unprinted page information. Thereafter, the DFE-side controller 311 allows the DFE-side communication device 35 to send a request to suspend printing and the printable page information via the second communication cable 5 to the first controller 211 of the image forming apparatus 2 (S242).

When receiving the above request to suspend printing and printable page information, the first controller 211 of the image forming apparatus 2 outputs a notification of suspension of printing and the printable page information to the second controller 241. The second controller 241 allows the image forming device 25 to perform printing in accordance with the printable page information. In the case where the printable page information includes information on the first to fifth pages, the image forming device 25 prints the first to fifth pages and then suspends printing (S142). Thereafter, the second controller 241 sends a printing completion notification to the first controller 211 and the first controller 211 sends the printing completion notification via the second communication cable 5 to the DFE-side communication device 35 (S143).

When the DFE-side communication device 35 receives the printing completion notification, the DFE-side controller 311 allows the DFE-side display device 33 to display an error message informing that printing has been suspended because of a communication error (S243). On the other hand, the first controller 211 allows the apparatus-side display device 221 to display the error massage and a restart instruction button (S144).

When the apparatus-side input acceptance device 22 accepts an input for selecting the restart instruction button (YES in S145), the first controller 211 sends a restart notification via the second communication cable 5 to the DFE-side communication device 35 (S147) and proceeds to restart processing (S148). When the DFE-side communication device 35 receives the restart notification (YES in S244), the DFE-side controller 311 executes the restart processing (S245).

Likewise, also when a predetermined time (for example, one minute) has passed while the apparatus-side input acceptance device 22 has not yet accepted an input for selecting the restart instruction button (NOT-YET-INPUT in S145 and YES in S146), the first controller 211 sends a restart notification via the second communication cable 5 to the DFE-side communication device 35 (S147) and proceeds to restart processing (S148). When the apparatus-side input acceptance device 22 accepts, not an input for selecting the restart instruction button, but an input for selecting a button instructing to cancel restart (NO in S145), the first controller 211 ends the processing.

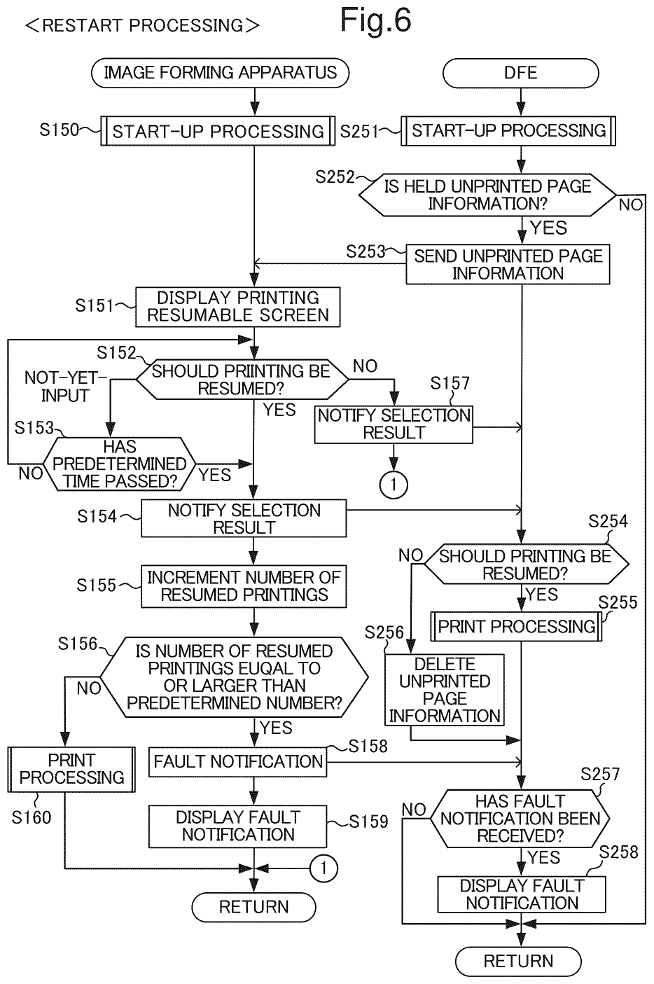

Next, a description will be given of restart processing to be executed upon occurrence of a communication error. FIG. 6 is a flowchart showing the flow of the restart processing.

The first controller 211 of the image forming apparatus 2 switches the image forming apparatus 2 from a power-off state to a power-on state and executes the start-up processing shown in FIG. 3 (S150). Likewise, the DFE-side controller 311 of the DFE 3 switches the DFE 3 from a power-off state to a power-on state and executes the start-up processing shown in FIG. 3 (S251). Then, in the case where the DFE-side storage device 35 holds unprinted page information (YES in S252), the DFE-side controller 311 sends the unprinted page information via the second communication cable 5 to the first controller 211 of the image forming apparatus 2 (S253).

When receiving the unprinted page information, the first controller 211 of the image forming apparatus 2 allows the apparatus-side display device 221 to display a printing resumption instruction button as a printing resumable screen (S151). When the apparatus-side input acceptance device 22 accepts an input for selecting the printing resumption instruction button (YES in S152), the first controller 211 sends a notification of execution of printing resumption via the second communication cable 5 to the DFE-side communication device 35 (S154).

Also when a predetermined time (for example, two minutes) has passed while the apparatus-side input acceptance device 22 has not yet accepted an input for selecting the printing resumption instruction button (NOT-YET-INPUT in S152 and YES in S153), the first controller 211 sends a notification of execution of printing resumption via the second communication cable 5 to the DFE-side communication device 35 (S154) in order to execute printing resumption. When the DFE-side communication device 35 receives the notification of execution of printing resumption (YES in S254), the DFE-side controller 311 proceeds to print processing (S255). The print processing is the processing already described with reference to FIG. 4.

When the apparatus-side input acceptance device 22 accepts an input for selecting a button instructing to cancel printing resumption (NO in S152), the first controller 211 sends a notification of canceling printing resumption via the second communication cable 5 to the DFE-side communication device 35 of the DFE 3 (S157). When the DFE-side communication device 35 receives the notification of canceling printing resumption (NO in S254), the DFE-side controller 311 deletes the unprinted page information stored in the DFE-side storage device 34 (S256).

After the first controller 211 of the image forming apparatus 2 sends the notification of execution of printing resumption, the first controller 211 increments the number of resumed printings (S155). The number of resumed printings is stored in a memory (not shown) included in the main control device 21 and the number of resumed printings stored in the memory is that due to communication error. When the number of resumed printings is less than a predetermined number (for example, five) (NO in S156), the first controller 211 proceeds to the print processing (S160).

In the print processing executed in this case, the second controller 241 determines the numbers of pages to be printed based on the unprinted page information and allows the image forming device 25 to print the pages. For example, when the unprinted page information includes information on the sixth to tenth pages, the second controller 241 allows the image forming device 25 to print images of the sixth to tenth pages.

When the number of resumed printings is equal to or larger than the predetermined number (YES in S156), the first controller 211 sends a fault notification via the second communication cable 5 to the DFE-side communication device 35 of the DFE 3 (S158) and allows the apparatus-side display device 221 to display a message of a fault notification (S159). Furthermore, when the DFE-side communication device 35 of the DFE 3 receives the fault notification (YES in S257), the DFE-side controller 311 allows the DFE-side display device 33 to display a message of the fault notification (S258).

As thus far described, even if printing is suspended due to the occurrence of a communication error while image data is sent from the DFE 3 to the image forming apparatus 2, printing can be smoothly resumed where it has been left off after the restart of the image forming apparatus 2.

For example, among apparatuses not according to the above embodiment, there is an apparatus that issues an appropriate error notification upon occurrence of an error. However, this apparatus is not clear about how printing is resumed after the occurrence of an error. Although, as described previously, there is an image forming apparatus not according to the above embodiment, wherein errors having occurred before the entry of a print job into the image forming apparatus are recorded in job execution history, this image forming apparatus does not employ any configuration for dealing with an error occurring after the entry of a print job. In the previously described image formation system not according to the above embodiment, a previous status of connection of the image formation system is stored and, upon a new connection, the user is prompted to confirm settings so that appropriate measures for the new connection can be taken. However, this image formation system is not clear about how an unprocessed print job is dealt with after the establishment of the new connection. Although, as described previously, a system not according to the above embodiment is proposed in which when a communication error occurs between a digital front end and an image forming apparatus during printing, predetermined processing is executed on the image forming apparatus side after the occurrence of the communication error in order to execute suspended processing without trouble to the user, this system is not clear about processing on the digital front end side.

Since, unlike the above general techniques, the above embodiment according to the present disclosure includes the structure and configuration described above and executes the above-described series of processing, even if printing is suspended due to the occurrence of a communication error while image data is sent from the digital front end to the image forming apparatus, printing can be smoothly resumed where it has been left off after the restart of the image forming apparatus.

The present disclosure is not limited to the above embodiment and can be modified in various ways. The structure, configuration, and processing of the above embodiment described with reference to FIGS. 1 to 6 are merely illustrative of the present disclosure and are not intended to limit the present disclosure to them.

While the present disclosure has been described in detail with reference to the embodiments thereof, it would be apparent to those skilled in the art that the various changes and modifications may be made therein within the scope defined by the appended claims.

What is claimed is:

1. An image formation system comprising a digital front end and an image forming apparatus, wherein
when communication is interrupted due to a communication error during sending of image data from the digital front end to the image forming apparatus, the image forming apparatus does printing halfway in accordance with already received part of the image data and the digital front end stores information on pages of the image data left unprinted by the image forming apparatus, and
after restart of the digital front end and the image forming apparatus, the digital front end sends the information on the pages left unprinted to the image forming apparatus and the image forming apparatus resumes the printing in accordance with the information on the pages left unprinted.

2. The image formation system according to claim 1, wherein
when the communication of the image forming apparatus with the digital front end is interrupted and the image forming apparatus does printing halfway in accordance with already received part of the image data, the image forming apparatus sends a printing completion notification indicating that the printing has been completed halfway to the digital front end, and
when receiving the printing completion notification, the digital front end allows a display device included in the digital front end to display an error message indicating that the printing has been suspended halfway.

3. The image formation system according to claim 1, wherein
when communication is interrupted due to a communication error during sending of the image data from the digital front end to the image forming apparatus, the image forming apparatus accepts an input for selecting an instruction to restart the image forming apparatus or an instruction not to restart the image forming apparatus from a user, and
when the image forming apparatus accepts the instruction to restart the image forming apparatus or accepts no instruction even though a predetermined time has passed, the image forming apparatus does printing halfway in accordance with the already received part of the image data and then restarts and the digital front end stores the information on the pages left unprinted by the image forming apparatus and then restarts.

4. The image formation system according to claim 1, wherein
when communication is interrupted due to a communication error during sending of the image data from the digital front end to the image forming apparatus and the image forming apparatus and the digital front end then restart, the image forming apparatus then accepts an input for selecting an instruction to resume the printing or an instruction not to resume the printing from a user, and
when the image forming apparatus accepts the instruction to resume the printing or accepts no instruction even though a predetermined time has passed, the digital front end sends the information on the pages left unprinted to the image forming apparatus and the image forming apparatus resumes the printing in accordance with the information on the pages left unprinted.

5. The image formation system according to claim 3, wherein
when communication is interrupted due to a communication error during sending of the image data from the digital front end to the image forming apparatus and the image forming apparatus and the digital front end then restart, the image forming apparatus then accepts an input for selecting an instruction to resume the printing or an instruction not to resume the printing from a user,
when the image forming apparatus accepts the instruction to resume the printing or accepts no instruction even though a predetermined time has passed, the image forming apparatus adds 1 to a number of resumed printings stored therein,
when the number of resumed printings is equal to or larger than a predetermined number, the image forming apparatus executes processing for notifying the user of an abnormality in the apparatus, and
when the number of resumed printings is less than the predetermined number, the digital front end sends the information on the pages left unprinted to the image forming apparatus and the image forming apparatus resumes the printing in accordance with the information on the pages left unprinted and, after completion of the printing, resets the number of resumed printings to zero and stores the reset number of resumed printings.

6. The image formation system according to claim 1, wherein the digital front end is connected via gigabit Ethernet to the image forming apparatus.
